(19) United States
(12) Patent Application Publication
(10) Pub. No.: US 2014/0019583 A1
(43) Pub. Date: Jan. 16, 2014

(54) INGEST BANDWIDTH REDUCTION FOR CLOUD BASED MEDIA SERVICES

(71) Applicant: ITTIAM SYSTEMS (P) LTD., Bangalore (IN)

(72) Inventor: SRIRAM SETHURAMAN, Bangalore (IN)

(73) Assignee: ITTIAM SYSTEMS (P) LTD., Bangalore (IN)

(21) Appl. No.: 13/897,364

(22) Filed: May 18, 2013

(30) Foreign Application Priority Data
Jul. 13, 2012 (IN) 2855/CHE/2012

(51) Int. Cl. H04L 29/06

(52) U.S. Cl. CPC H04L 65/601
USPC 709/217

(57) ABSTRACT

An automated system and method for ingest bandwidth reduction while uploading media content acquired at a given bit-rate to a cloud based media service are disclosed. In one embodiment, the media content is converted to a lower bit-rate coded representation than the given bit-rate using one of an electronic device used for initiating the upload and a dedicated appliance connected to the electronic device. Further, the converted media content is uploaded to the cloud based media service using one of the electronic device and the dedicated appliance either in sequence or in parallel with the conversion.

Benefit is claimed under 35 U.S.C 119(a) to Indian Provisional Patent Application Serial No. 2855/CHE/2012 entitled “SYSTEM AND METHOD FOR INGEST BANDWIDTH REDUCTION IN CLOUD BASED MEDIA SERVICES” by Ittiam Systems (P) Ltd. filed on Jul. 13, 2012.

### FIELD OF TECHNOLOGY

Embodiments of the present invention relate to processing of media content for cloud based media services. More particularly, embodiments of the present invention relate to ingest bandwidth reduction for the cloud based media services.

### BACKGROUND

Existing cloud based media services require organizations or individuals to upload higher quality media content to a web portal. The uploaded media content then gets re-purposed to multiple forms according to the requirements of the organizations or the cloud service. The re-purposed media content then gets uploaded to a web server or web storage for further dissemination. Such cloud based media services are aimed at enabling “pay as you go” models (in lieu of capital intensive dedicated infrastructure) that are elastic based on the needs of the service. Further, such cloud based media services frees up a service provider from needing to have personnel knowledgeable about media technologies. Typically, the upload of high quality media content may require a very high bandwidth to the extent that the cost of upload may far exceed the cost of the cloud based media services. For free cloud media services, performing compute intensive cloud based transcoding involves a high cloud computing cost that they desire to bring down. Also, in the absence of a high bandwidth connection, the upload time determines turn-around time for the cloud based media services, which may affect live streaming services and may result in a poor user experience for consumers of the cloud based media services.

### BRIEF DESCRIPTION OF THE DRAWINGS

Embodiments of the present invention are illustrated by way of an example and not limited to the figures of the accompanying drawings, in which like references indicate similar elements and in which:

FIG. 1 illustrates a block diagram of a system for ingest bandwidth reduction for a cloud based media service, according to one embodiment;

FIG. 2 is a block diagram which illustrates major functional sub-components of a cloud ingest bandwidth reduction module (CIBRM), such as the one shown in FIG. 1, according to one embodiment; and

FIG. 3 illustrates an automated method for ingest bandwidth reduction for a cloud based media service, according to one embodiment.

Other features of the present embodiments will be apparent from the accompanying drawings and from the detailed description that follows.

### DETAILED DESCRIPTION

An automated system and method for ingest bandwidth reduction for cloud based media services are disclosed. In the following detailed description of the embodiments of the invention, reference is made to the accompanying drawings that form a part hereof, and in which are shown, by way of illustration, specific embodiments in which the invention may be practiced. These embodiments are described in sufficient detail to enable those skilled in the art to practice the invention, and it is to be understood that other embodiments may be utilized and that changes may be made without departing from the scope of the present invention. The following detailed description is, therefore, not to be taken in a limiting sense, and the scope of the present invention is defined by the appended claims.

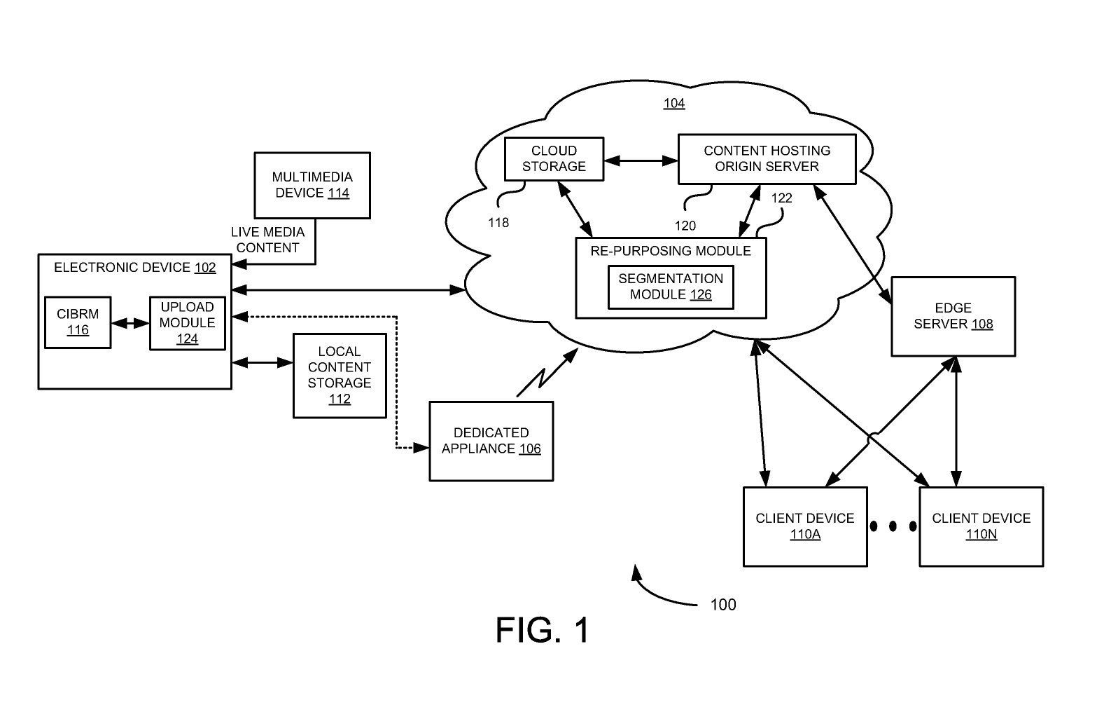

FIG. 1 illustrates a block diagram of a system 100 for ingest bandwidth reduction for a cloud based media service 104, according to one embodiment. Exemplary cloud based media service 104 includes a cloud based media locker services, online video transcoding, cloud based media hosting, cloud based media encoding and the like. As shown in the FIG. 1, the system 100 includes an electronic device 102, the cloud based media service 104, an edge server 108, a plurality of client devices 110A-N, a local content storage 112, and a multimedia device 114. Exemplary electronic device 102 includes a tablet, smart phone, a personal computer, a laptop and the like. In one embodiment, the system 100 includes a dedicated appliance 106. Further, the cloud based media service 104 includes a cloud storage 118, a content hosting origin server 120, and a re-purposing module 122. Furthermore, the electronic device 102 includes a cloud ingest bandwidth reduction module (CIBRM) 116 and an upload module 124. In some embodiments, the CIBRM 116 and the upload module 124 may reside in the dedicated appliance 106 and the cloud ingest bandwidth reduction process can be performed at the uploading end.

In addition as shown in FIG. 1, the electronic device 102 is connected to the dedicated appliance 106. In one example embodiment, the dedicated appliance 106 is connected to the electronic device 102 over a universal serial bus (USB). In this example embodiment, the dedicated appliance 106 can draw power over the USB from the electronic device 102. In this example embodiment, the dedicated appliance 106 includes a wireless modem and a radio-frequency interface. In another example embodiment, the dedicated appliance 106 is connected to the electronic device 102 over a wireless link. In this example embodiment, the dedicated appliance 106 also acts as a wide area network router or a home media gateway appliance. Moreover, the dedicated appliance 106 is communicatively connected to the cloud based media service 104. Also, the cloud based media service 104 is communicatively connected to the client devices 110A-N and the edge server 108. Further, the electronic device 102 is connected to the local content storage 112 and the cloud based media service 104. Furthermore, the multimedia device 114 is connected to the electronic device 102.

In operation, a user of the cloud based media service 104 selects media content acquired at a given bit-rate for upload and specifies a set of re-purposing profiles for the media content in the electronic device 102 as a web service. For example, the media content includes audio streams, speech, images, screen-captures, graphics, video streams and the like. In one example embodiment, the media content for upload is available on the local content storage 112 physically connected to or within the electronic device 102. In another example embodiment, the media content is live media content obtained from the multimedia device 114, such as a camera and the like. In this example embodiment, the live media content is useful to directly feed the camera or screen-capture output.

Further, the CIBRM 116 converts the media content to a lower bit-rate coded representation than the given bit-rate. In some embodiments, the CIBRM 116 converts the media content to the lower bit-rate coded representation based on parameters including properties of the media content, a bandwidth available for the upload, computing capabilities of the electronic device 102 or the dedicated appliance 106, power and battery life requirements of the electronic device 102 and/or the dedicated appliance 106, requirements of the cloud based media service 104, requirements on live or stored processing, user experience requirements and the like. In one embodiment, the CIBRM 116 edits the media content by performing one or more of removing unwanted time segments from the media content, blending or interleaving time segments from the media content stored, live streamed or graphically rendered and creating transition effects across the different scenes in the media content. In other words, the CIBRM 116 can also be used to combine sequentially or blend multiple sources of media content that are stored or live, such as one media file that is stored, second media content that is captured live using the sensor(s) on the electronic device, third media content that is generated live through screen capture, and fourth media content that is graphically rendered.

In another embodiment, the CIBRM 116 scales the media content according to the resolution requirements of the cloud based media service 104, converts the frame-rate of the media content according to the frame-rate requirements of the cloud based media service 104, removes noise from the media content or selectively smoothing details in a visually pleasing manner to improve its compressibility, and/or de-interlaces any interlaced media content. In yet another embodiment, the CIBRM 116 performs transcoding, trans-scaling, and/or trans-rating of the media content. In one example, the lower bit-rate coded representation can be a scalably coded representation that covers a plurality of media resolutions and/or a plurality of bit-rates. The CIBRM 116 then re-uses information generated during decoding of the media content to reduce the computational complexity of performing transcoding, trans-scaling, and/or trans-rating.

Furthermore, the upload module 124 uploads the converted media content to the cloud based media service 104. The upload can start as soon as a portion of the converted lower bit-rate media content starts becoming available or it can start at a later time. In one example embodiment, the CIBRM 116 performs media content analytics. The upload module 124 then uploads the analytics information synchronized with the converted media content. In another example embodiment, the CIBRM 116 generates closed caption data or sub-titles data. The upload module 124 then uploads the closed caption data or sub-titles data synchronized with the converted media content. In yet another example embodiment, the CIBRM 116 encrypts the converted media content.

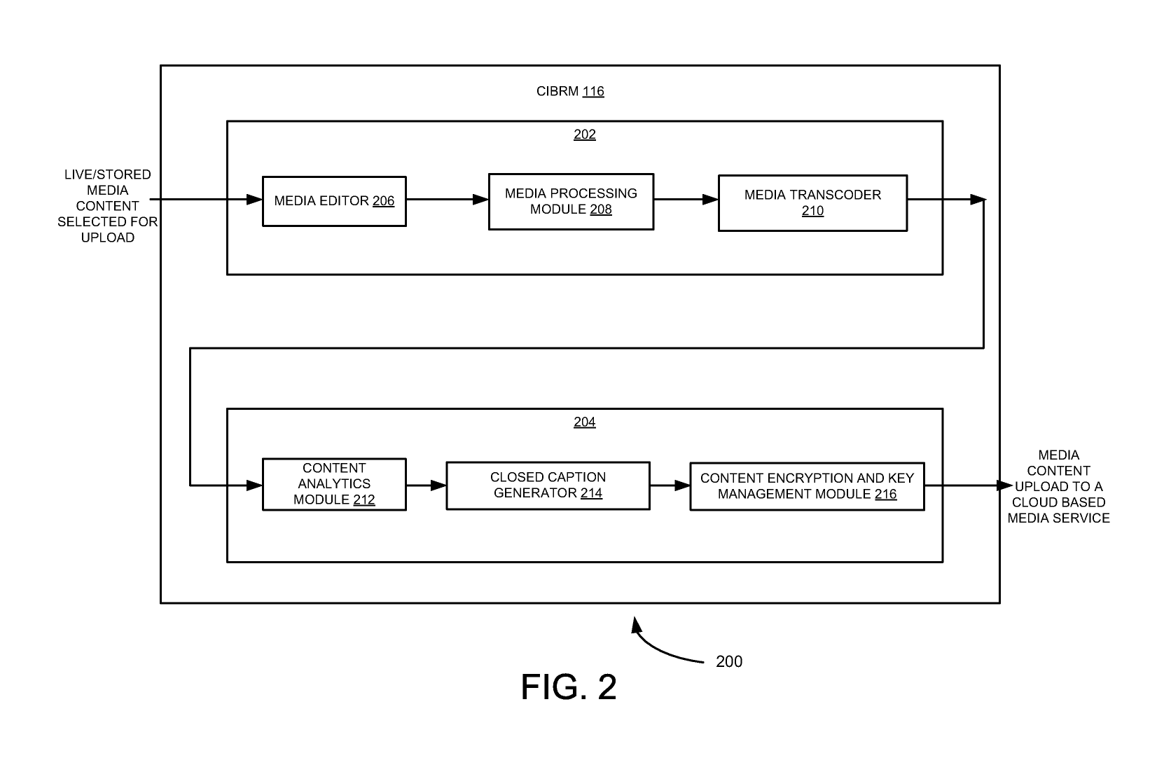

The upload module 124 then uploads the encrypted media content. This is explained in more detail with reference to FIG. 2.

one exemplary embodiment, the CIBRM 116 converts the media content to a lower media resolution than an original media resolution based on the upload bandwidth available and the computing capabilities of the electronic device 102 or the dedicated appliance 106 to facilitate a live processing pipeline. The upload module 124 then uploads the converted media content progressively along with the conversion. In one embodiment, the conversion of the original media resolution to additional media resolutions and/or bit-rates and their upload to the cloud based media service 104 is deferred in a manner not to affect the performance of the live processing pipeline. In another embodiment, the upload of the original media content is deferred to the cloud based media service 104 in a manner not to affect performance of the live processing pipeline. In one example, the CIBRM 116 creates a scalably coded representation across a set of media resolutions and/or bit-rates required. In this example, the scalably coded representation is constructed to include the lower media resolution. The upload module 124 then uploads the scalably coded representation to the cloud based media service 104 in a manner not to affect the performance of the live processing pipeline.

In another exemplary embodiment, the upload module 124 takes the converted media content or the original media content and, optionally, breaks into multiple chunks of media content. The upload module 124 then uploads the multiple chunks of the media content to the cloud based media service 104. For example, the upload of the converted media content can be pipelined with the cloud ingest bandwidth reduction process to minimize the latency incurred.

In yet another exemplary embodiment, the upload module 124 uploads re-encoding hints or metadata, generated by the CIBRM 116, about the media content synchronized with the converted media content for reducing the amount of computations required on the cloud based media service 104.

In the above example embodiments, the upload of the media content can be done over wired or wireless networks. In the embodiments where a wireless network is used (e.g., Wi-Fi, a third generation (3G) network, a long-term evolution (LTE) network and so on), the dedicated appliance 106 can be provisioned to take care of both the computing needs and the communication needs. For example, the dedicated appliance 106 can be a USB dongle device with a system on chip (SoC) similar to SoCs used in smart phones that come with the required radio interfaces, a modem, and an application processor. Such a device can be powered over the USB and can access the input media content also over the USB. Such packaging allows a telecommunications service provider to bundle the dongle as part of their service and avoid the high bandwidth streams from clogging their networks. The bundling can also serve to show that as if there is considerable computing happening at the user end itself. Some examples of the form that the dedicated appliance 106 can take are USB powered, media data read/write over USB dongle form factor, a small box with external power supply and Gigabit Ethernet connectivity, a peripheral component interconnect express (PCIe) or Thunderbolt add-on card powered by a host desktop, a personal computer memory card international association (PCMCIA) or similar form-factor card that is powered by a host laptop or similar device, a rack unit that aggregates the processing requirements of multiple tenants or multiple jobs of a single tenant having connectivity over 1G/10G Ethernet, and a home media gateway having an embedded functionality in a home media gateway or router appliance that is capable of connecting a in-home local area network (LAN) to a wide area network (WAN).

In addition in operation, purposing module 122 checks the format of the uploaded media content. If the format is same as the format needed at the output of the re-purposing module 122, then the re-purposing module 122 skips any media transcoding step. Otherwise, the re-purposing module 122 decodes the uploaded stream and the associated metadata, and transcodes the media content to one or more forms based on the output resolution, frame-rate, bit-rate requirements of the cloud based media service 104. For example, the re-purposing may be for adaptive bit-rate streaming using techniques, such as a dynamic adaptive streaming over hypertext transfer protocol (MPEG-DASH), HTTP live streaming (HLS), smooth streaming, HTTP dynamic streaming, and so on. In one example embodiment, a segmentation module 126 residing in the re-purposing module 122 can be used to chunk the media content into multiple segments based on the above desired services.

In one embodiment, the re-purposing module 122 performs re-purposing of the media content only for a scalable representation, such as H.264 scalable video coding (SVC) or the scalable extension of high efficiency video coding (HEVC). Such scalable representations ease the overall storage requirements of live and on-demand services and also significantly improve the quality of experience (QoE) of end-users associated with the client devices 110A-N of live/on-demand streaming services. For example, the scalable representations help proxy caching (as one bit-rate builds on other bit-rates unlike with adaptive bit-rate streaming) and also allows for quick adaptation to available bit-rate by intelligent routers. In cases where the uploaded media content is a scalable bit stream, the transcoding to multiple resolutions, frame-rate, and bit-rate can be done from a single instance of the re-purposing module 122. In one example embodiment, the transcoding of the media content can leverage the information in the incoming bit stream as well as the metadata sent along with the bit stream to intelligently transcode and minimize the computational requirements needed for the transcoding. The re-purposing module 122 then stores the output media content in the cloud storage 118 after adding required digital rights management protection to the media content.

Moreover, the content hosting origin server 120 hosts the uniform resource locators (URLs) to each segment produced and serves the segments based on requests from the client devices 110A-N or the edge server 108. In one example embodiment, the content hosting origin server 120 may also choose to multicast the media content or pro-actively send portions of the media content to the edge server 108. Also, the edge server 108 takes over the actual delivery of the media content to the client devices 110A-N (e.g., smart phones, tablets, laptops, and so on) which are subscribed to either a live session or an on-demand clip. The edge server 108 (e.g., a proxy server) also switches to a different bit-rate stream on segment boundaries based on a request from the client devices 110A-N on available bandwidth or buffer occupancy. In anticipation, the edge server 108 generates requests to the content hosting origin server 120 to cache the media contents and decides appropriate time-to-live for each media content. In addition, the client devices 110A-N collects statistics on key user experience parameters, such as freezes, buffer occupancy and so on and forwards the collected statistics to the edge server 108. For on-demand sessions, controls, such as fast-forward, rewind, seek, pause, resume are initiated from the client devices 110A-N.

In one example scenario, when the compute power of the dedicated appliance 106 is aggregated across a multi-tenanted organization (i.e. more than one user of the cloud based media service 104 within a single facility) or when multiple jobs of a single user have to be parallelly uploaded, they can be housed in a single place within the site. This can be viewed as a private cloud based media service within the organization which then prepares the media content for upload to another public/private cloud based media service.

In an example embodiment, the above cloud ingest bandwidth reduction process can be performed only on a portion of the media content and the rest of the media content is uploaded in an as is form. The selection of which portion of the media content can go through the cloud ingest bandwidth reduction process may be based on battery life considerations or on how quickly the media content needs to be made available on the cloud based media service 104 and the compute capacity of the electronic device 102 used to initiate the upload or the dedicated appliance 106 connected to the electronic device 102. For instance, to leverage the compute power available at the upload side, a first portion of the media content may be converted to a lower bit-rate coded representation locally, while the second portion may be uploaded as is. Alternatively, the first portion that is converted locally can be interleaved (in time) with the second portion of the media content that are uploaded as is. It can be seen that in both cases, both the upload cost and cloud compute cost are significantly reduced when compared with performing all operations in the cloud based media service 104.

Further, it should be noted that even after the cloud ingest bandwidth reduction, the upload module 124 may not be able to transfer the media content in real-time. Hence, the cloud ingest bandwidth reduction process itself can be non real-time. The above cloud ingest bandwidth reduction process can leverage this non real-time option to run more complex algorithms to further reduce the bandwidth without significantly altering the user experience with respect to the cloud based media service 104.

Referring now to FIG. 2, which is a block diagram 200 that illustrates major functional sub-components of the CIBRM 116, such as the one shown in FIG. 1, according to one embodiment. As shown in FIG. 2, the CIBRM 116 includes a cloud ingest bandwidth reduction related module 202 and a functionality related module 204. Further, the cloud ingest bandwidth reduction related module 202 includes a media editor 206, a media processing module 208 and a media transcoder 210. Furthermore, the functionality related module 204 includes a content analytics module 212, a closed caption generator 214 and a content encryption and key management module 216. In addition, the functionality related module 204 optionally resides in between the cloud ingest bandwidth reduction related module 202 and an upload module (e.g., the upload module 124 of FIG. 1).

In one embodiment, the media editor 206 performs one or more of removing unwanted time segments from the media content, blending or interleaving time segments from the media content stored, live streamed or graphically rendered and creating transition effects across the different scenes in the media content. In one example embodiment, the media editor 206 performs shot boundary detection which is used to remove the unwanted parts of the media content. In another example embodiment, the media editor 206 is used to post-produce raw footage to provide visually pleasing transitions from one shot to another. Further, the media processing module 208 scales the media content, converts the frame-rate of the media content, removes noise from the media content or selectively smoothes details in a visually pleasing manner to improve its compressibility and de-interlaces the content depending on the highest re-purposing setting in terms of resolution, frame-rate, and progressive/interlaced scan. This is explained in more detail with reference to FIG. 1.

Furthermore, the media transcoder 210 checks the format of the video stream in the media content chosen for the upload. If the format is not high efficiency video coding (HEVC) or its future extensions, it decodes the media content and converts it to a HEVC compliant bit stream. If the media content is in the HEVC format, then the media transcoder 210 trans-rates the media content. For example, the media transcoder 210 performs transcoding and/or trans-rating to achieve a reduction in bandwidth compared to the input media content, while maintaining a quality level that is sufficient for all the re-purposing needs in a cloud based media service (e.g., the cloud based media service 104 of FIG. 1). For example, the media transcoder 210 can be an intelligent transcoder that leverages the information embedded in the input bit stream to reduce the computational complexity of the transcoding operation. It should be noted that when the media processing module 208 is used, the media transcoder 210 may straddle the media processing module 208 by first decoding the media content in a form suitable for the media processing module 208 and then re-encoding the media content at the output of the media processing module 208.

Also, the media transcoder 210, in addition to the transcoded or trans-rated media content, prepares additional metadata, such as scene cut positions, coding mode hints at other bit-rates, face detection output, type of editing effect used across scenes and its parameters and so on synchronized with the media content to assist downstream re-purposing in the cloud based media service. In one example embodiment, the media transcoder 210 may, optionally, produce HEVC streams at more than a single resolution. In another example embodiment, the media transcoder 210 may also produce streams that conform to a scalable extension of the HEVC (where the scalability can be temporal, spatial, or quality scalability). For example, the primary need for the additional stream(s) is to produce a stream at a bandwidth that is matched to the upload bandwidth available, so that live re-purposing and hosting become possible. In the above example embodiments, the transcoded higher resolution/quality/frame-rate stream(s) or the scalable enhancement layers may be stored locally for later upload (to not affect the upload of the live stream) so that the same media content can be made available for re-purposing for on-demand services later at a higher quality.

In some embodiments, where a user of the cloud based media service only uploads media content to produce a single transcoded bit stream or when the media content clips duration is rather short that the multi-stream generation locally is cheaper than uploading and then downloading the different streams from the cloud based media service, the entire transcoding can happen locally. This saves the tedious task of scheduling/provisioning the cloud based media service for a simple job (which may be inefficient as the granularity of provisioning may be much coarser when compared to the clip duration).

Although the above technique is described using HEVC format, one can envision that any past/future high efficiency video compression method (standard or proprietary formats) that provides cloud ingest bandwidth reduction over the incoming video format can be employed. If the cloud based media service is the only consumer of the transcoded or trans-rated media content, any proprietary encoding method can be used. In such scenarios, special group of pictures (GOP) structures can also be used. For example, expensive intra pictures can be coded only at shot/scene boundaries or at bit stream chunk boundaries (say, once every 10 s) as random access may not be a requirement. Further, in cases, where there is no dedicated appliance (e.g., the dedicated appliance 106 of FIG. 1) or where the compute power of an electronic device (e.g., the electronic device 102 of FIG. 1) used to initiate the upload is not sufficient for the cloud ingest bandwidth reduction process or where the upload bandwidth available is sufficient and associated cost is acceptable, the workflow simplifies to skipping one or more stages of the cloud ingest bandwidth reduction related module 202.

In one example embodiment, the content analytics module 212 extracts analytics, such as recognizable face and runs the key word spotting types of analytics. Such analytics can be used to better tag the media content for easy indexing/retrieval. Further, the closed caption generator 214 adds automatic closed caption data or sub-titles data as ancillary information (if not already present in the input media content) through speech to text conversion in the language of the media content. Furthermore, the content encryption and key management module 216 encrypts the media content chosen for upload at the end of the cloud ingest bandwidth reduction processing stage in order to provide content protection while the media content is in flight or kept in the content lockers. This is explained in more detail with reference to FIG. 1.

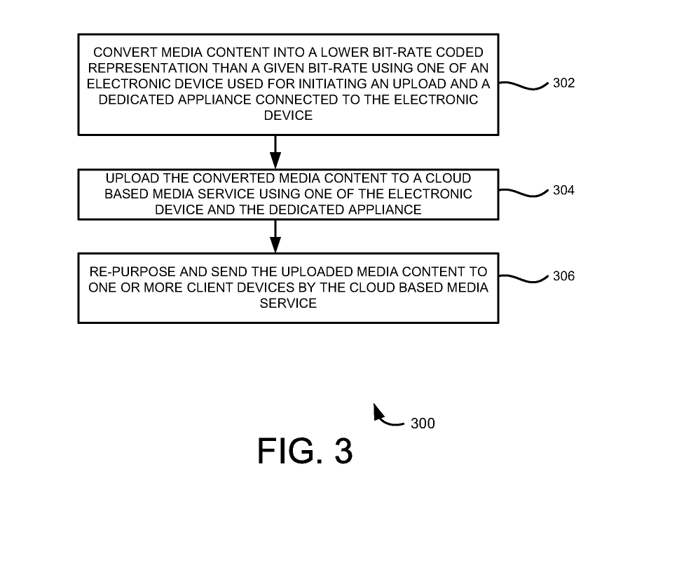

Referring now to FIG. 3, which illustrates an automated method 300 for ingest bandwidth reduction for a cloud based media service, according to one embodiment. At block 302, media content, acquired at a given bit-rate, is converted to a lower bit-rate coded representation than the given bit-rate using one of an electronic device used for initiating an upload to the cloud based media service and a dedicated appliance connected to the electronic device. In one example embodiment, the media content is converted to the lower bit-rate representation based on parameters including properties of the media content, a bandwidth available for the upload, computing capabilities of the electronic device or the dedicated appliance, power and battery life requirements of the electronic device and/or the dedicated appliance, requirements of the cloud based media service, requirements on live or stored processing, user experience requirements and the like. Further, the conversion of the media content to the lower bit-rate coded representation is performed using a group of processing steps including editing the media content, processing the media content, and transcoding the media content. At block 304, the converted media content is uploaded to the cloud based media service using one of the electronic device and the dedicated appliance either in sequence or in parallel with the conversion. In one example embodiment, the uploading of the converted media content to the cloud based media service is scheduled based on parameters including a bit-rate of the converted lower bit-rate representation, a bandwidth available for the upload, requirements on live or stored processing, user experience requirements and the like. At block 306, the uploaded media content is re-purposed and sent to one or more client devices by the cloud based media service. This is explained in more detail with reference to FIGS. 1 and 2.

In one embodiment, an article comprising a non-transitory computer readable storage medium having instructions thereon which when executed by a computing platform result in execution of the above mentioned method. The method described in the foregoing may be in a form of a machine-readable medium embodying a set of instructions that, when executed by a machine, causes the machine to perform any method disclosed herein. It will be appreciated that the various embodiments discussed herein may not be the same embodiment, and may be grouped into various other embodiments not explicitly disclosed herein.

In various embodiments, the systems and methods described in FIGS. 1 through 3 propose a technique for ingest bandwidth reduction while uploading media content acquired at a given bit-rate to a cloud based media service by converting the media content to a lower bit-rate representation than the given bit-rate using one of an electronic device used for initiating the upload and a dedicated appliance connected to the electronic device. Therefore, the above technique reduces the cost of upload, the computation cost in the cloud based media service, storage requirements in the cloud based media service. Further, the above technique enhances user experience of end-users of the cloud based media service.

In addition, it will be appreciated that the various operations, processes, and methods disclosed herein may be embodied in a machine-readable medium and/or a machine accessible medium compatible with a data processing system (e.g., a computer system), and may be performed in any order (e.g., including using means for achieving the various operations). Accordingly, the specification and drawings are to be regarded in an illustrative rather than a restrictive sense.

What is claimed is:

1. An automated method for ingest bandwidth reduction while uploading media content acquired at a given bit-rate to a cloud based media service, comprising:
converting the media content to a lower bit-rate coded representation than the given bit-rate using one of an electronic device used for initiating the upload and a dedicated appliance connected to the electronic device; and
uploading the converted media content to the cloud based media service using one of the electronic device and the dedicated appliance.

2. The method of claim 1, wherein the media content is converted to the lower bit-rate coded representation based on parameters selected from the group consisting of properties of the media content, a bandwidth available for the upload, computing capabilities of the electronic device or the dedicated appliance, power and battery life requirements of the electronic device and/or the dedicated appliance, requirements of the cloud based media service, requirements on live or stored processing, and user experience requirements.

3. The method of claim 1, wherein uploading of the converted media content to the cloud based media service is scheduled based on parameters selected from the group consisting of, a bit-rate of the converted lower bit-rate representation, a bandwidth available for the upload, requirements on live or stored processing, and user experience requirements.

4. The method of claim 3, wherein uploading of the converted media content happens concurrently with the step of converting the media content to the lower bit-rate coded representation.

5. The method of claim 1, wherein converting the media content to the lower bit-rate coded representation comprises:
editing the media content to perform at least one of,
removing unwanted time segments;
blending or interleaving time segments from media content stored, live streamed or graphically rendered; and
creating transition effects across different scenes in the media content.

6. The method of claim 1, wherein the conversion of the media content to the lower bit-rate coded representation is performed using a group of processing steps comprising of, editing the media content, processing the media content, and transcoding the media content.

7. The method of claim 1, wherein converting the media content to the lower bit-rate coded representation comprises at least one of:
scaling the media content based on resolution requirements of the cloud based media service;
converting frame-rate of the media content based on frame-rate requirements of the cloud based media service;
removing noise from the media content or selectively smoothing details in a visually pleasing manner to improve compressibility of the processed media content; and
de-interlacing any interlaced media content.

8. The method of claim 1, wherein converting the media content to the lower bit-rate coded representation comprises:
performing transcoding, trans-scaling, and/or trans-rating of the media content.

9. The method of claim 8, wherein the lower bit-rate coded representation is a scalably coded representation that covers a plurality of media resolutions and/or a plurality of bit-rates.

10. The method of claim 8, further comprising:
re-using information generated during decoding of the media content to reduce computational complexity of performing the transcoding, the trans-scaling, and/or the trans-rating.

11. The method of claim 1, further comprising:
generating and uploading re-encoding hints or metadata about the media content synchronized with the converted media content for reducing an amount of computations required on the cloud based media service.

12. The method of claim 1, further comprising:
performing media content analytics; and
uploading the analytics information synchronized with the converted media content.

13. The method of claim 1, further comprising:
generating closed caption data or sub-titles data; and
uploading the closed caption data or sub-titles data synchronized with the converted media content.

14. The method of claim 1, further comprising:
encrypting the converted media content.

15. The method of claim 1, wherein converting the media content to the lower bit-rate coded representation comprises:
converting the media content to a lower media resolution than an original media resolution based on an upload bandwidth available and computing capabilities of the electronic device or the dedicated appliance to facilitate a live processing pipeline; and
uploading the converted media content progressively along with the conversion.

16. The method of claim 15, further comprising:
deferring the upload of the original media content to the cloud based media service in a manner not to affect performance of the live processing pipeline.

17. The method of claim 15, further comprising:
deferring the conversion of the original media resolution to additional media resolutions and/or bit-rates and their upload to the cloud based media service in a manner not to affect performance of the live processing pipeline.

18. The method of claim 15, further comprising:
creating a scalably coded representation across a set of media resolutions and/or bit-rates required; and
uploading the scalably coded representation to the cloud based media service in a manner not to affect the performance of the live processing pipeline.

19. The method of claim 1, further comprising:
converting only specific portions of the media content to a lower bit-rate representation prior to their upload, where the specific portions are selected from the group consisting of computing capabilities of the electronic device or the dedicated appliance, power or battery life requirements of the electronic device and/or the dedicated appliance, and user experience requirements.

20. The method of claim 1, wherein the dedicated appliance is connected to the electronic device over a universal serial bus (USB).

21. The method of claim 20, wherein the dedicated appliance draws power over the USB from the electronic device.

22. The method of claim 20, wherein the dedicated appliance comprises a wireless modem and a radio-frequency interface that is used to perform the upload of the converted media content to the cloud based media service.

23. The method of claim 1, wherein the dedicated appliance is connected to the electronic device over a wireless link.

24. The method of claim 23, wherein the dedicated appliance acts as a wide area network router or a home media gateway appliance.

25. The method of claim 1, wherein the media content includes audio streams, speech, images, screen-captures, video streams and graphics, wherein the cloud based media service includes a cloud based media locker services, online video transcoding, cloud based media hosting and cloud based media encoding, and wherein the electronic device is selected from the group consisting of a tablet, smartphone, a personal computer, and a laptop.

26. A system, comprising:
an electronic device; and
a cloud based media service, wherein the electronic device comprises a cloud ingest bandwidth reduction module (CIBRM) and an upload module, wherein the electronic device initiates an upload of media content acquired at a given bit-rate to the cloud based media service, wherein the CIBRM converts the media content to a lower bit-rate coded representation than the given bit-rate and wherein the upload module uploads the converted media content to the cloud based media service.

27. The system of claim 26, wherein the CIBRM converts the media content to the lower bit-rate coded representation based on parameters selected from the group consisting of properties of the media content, a bandwidth available for the upload, computing capabilities of the electronic device or the dedicated appliance, power and battery life requirements of the electronic device and/or the dedicated appliance, requirements of the cloud based media service, requirements on live or stored processing, and user experience requirements.

28. The system of claim 26, wherein the CIBRM converts the media content to the lower bit-rate coded representation using a group of processing steps comprising of, editing the media content, processing the media content, and transcoding the media content.

29. A system, comprising:
an electronic device;
a dedicated appliance connected to the electronic device; and
a cloud based media service, wherein one of the electronic device and the dedicated appliance comprises a cloud ingest bandwidth reduction module (CIBRM) and an upload module, wherein the electronic device initiates an upload of media content acquired at a given bit-rate to the cloud based media service, wherein the CIBRM converts the media content to a lower bit-rate coded representation than the given bit-rate and wherein the upload module uploads the converted media content to the cloud based media service.

30. The system of claim 29, wherein the CIBRM converts the media content to the lower bit-rate coded representation based on parameters selected from the group consisting of properties of the media content, a bandwidth available for the upload, computing capabilities of the electronic device or the dedicated appliance, power and battery life requirements of the electronic device and/or the dedicated appliance, requirements of the cloud based media service, requirements on live or stored processing, and user experience requirements.

31. The system of claim 29, wherein the CIBRM converts the media content to the lower bit-rate coded representation using a group of processing steps comprising of, editing the media content, processing the media content, and transcoding the media content.

32. A non-transitory computer-readable storage medium having instructions that when executed by a computing device, cause the computing device to:
convert media content, acquired at a given bit-rate, to a lower bit-rate coded representation than the given bit-rate using one of an electronic device used for initiating an upload to a cloud based media service and a dedicated appliance connected to the electronic device; and
upload the converted media content to the cloud based media service using one of the electronic device and the dedicated appliance.

33. The non-transitory computer-readable storage medium of claim 32, wherein the media content is converted to the lower bit-rate coded representation based on parameters selected from the group consisting of properties of the media content, a bandwidth available for the upload, computing capabilities of the electronic device or the dedicated appliance, power and battery life requirements of the electronic device and/or the dedicated appliance, requirements of the cloud based media service, requirements on live or stored processing, and user experience requirements.

34. The non-transitory computer-readable storage medium of claim 32, wherein the conversion of the media content to the lower bit-rate coded representation is performed using a group of processing steps comprising of, editing the media content, processing the media content, and transcoding the media content.
